(19) United States
(12) Patent Application Publication
(10) Pub. No.: US 2022/0135904 A1
(43) Pub. Date: May 5, 2022

(54) USE OF ETHOXYLATED ALCOHOLS TO IMPEDE ENVELOPED VIRAL SPREAD

(71) Applicant: MICROBAN PRODUCTS COMPANY, Huntersville, NC (US)

(72) Inventor: Gina Parise SLOAN, Statesville, NC (US)

(21) Appl. No.: 17/504,050

(22) Filed: Oct. 18, 2021

Related U.S. Application Data
(60) Provisional application No. 63/108,689, filed on Nov. 2, 2020.

(51) Int. Cl. C11D 1/72; C11D 3/16; C11D 11/00

(52) U.S. Cl. CPC C11D 1/72; C11D 11/0017; C11D 3/162; C11D 3/168

(57) ABSTRACT

A method is provided in which a combination of an ethoxylated alcohol and an antimicrobial agent is used to impede virus spread. The method is particularly suitable to impede enveloped virus spread.

### CROSS-REFERENCES TO RELATED APPLICATIONS

This application claims priority from U.S. Provisional Patent Application No. 63/108,689, filed on Nov. 2, 2020, in the United States Patent and Trademark Office. The disclosure of which is incorporated herein by reference in its entirety.

### FIELD OF THE INVENTION

The present invention relates to a method of impeding a virus, more particularly to a method for impeding an enveloped viral spread.

### BACKGROUND OF THE INVENTION

Viruses are sub-microscopic infectious particles that replicate inside living cells and cause diseases. Based on the presence or absence of an outer phospholipid bilayer, viral particles can be grouped into enveloped and non-enveloped viruses. Enveloped viruses, such as Influenza and Respiratory Syncytial Virus (RSV), can persist for up to 24 hours on environmental surfaces. Coronaviruses, also an enveloped virus, can persist for days on hard non-porous surfaces. Over the last decade, there have been four pandemics attributed to enveloped viruses such as strains of Coronavirus and Ebola.

Disinfectants are chemicals that can inactivate viruses within minutes; however, the disinfecting activity does not continue. For example, if a person touches, sneezes or interacts with a surface, new viral particles can be introduced post-disinfection making the newly-contaminated surface a vector of virus transmission. Traditional disinfectants are unable to provide long lasting protection that interrupts viral transmission.

There is a need to stop viral transmission via surfaces by application of a long-lasting antiviral protection on hard and soft surfaces, such as polymers and textiles, respectively.

Universally, a virus particle (virion) consists of nucleic acid surrounded by a protective coat of protein called a capsid. Enveloped virus particles have a phospholipid bilayer that encloses the capsid. This envelope is derived from the infected cell, or host, in a process called “budding off.” During the budding process, newly formed virus particles become “enveloped” or wrapped in an outer coat that is made from a small piece of the cell's plasma membrane. This envelope is required for subsequent attachment to and infection of new host cells.

Most antimicrobial agents, such as zinc- and silver-based antimicrobials, quaternary amine compounds, quaternary silanes, and organic acids, act to destroy the capsid or nucleic acid. In some instances, the level of active required to achieve full inactivation of viruses is such that the antimicrobial poses a risk to human health. Therefore, there is a need to accentuate the antiviral activity of antimicrobial actives without causing a concomitant increased risk of toxicity to humans.

Thus, the present invention provides a method that addresses and solves these needs.

### SUMMARY OF THE INVENTION

The present invention relates to a method for impeding an enveloped viral spread. The method comprises applying an ethoxylated alcohol to a substrate, wherein the application impedes an enveloped virus.

In an embodiment of the invention, a method of impeding virus spread is provided. The method comprises using a combination of an ethoxylated alcohol and an antimicrobial agent to impede virus spread. The method is particularly suitable for impeding enveloped virus spread.

In an embodiment of the invention, a method of using an ethoxylated alcohol is provided. The method comprises applying an ethoxylated alcohol and an antimicrobial agent to a substrate to impede virus spread. The method is particularly suitable for impeding enveloped virus spread.

In an embodiment of the invention, a method of using an ethoxylated alcohol is provided. The method comprises applying an ethoxylated alcohol and an antimicrobial agent to a substrate to impede virus spread. The method is particularly suitable for impeding enveloped virus spread.

In an embodiment of the invention, a method of using an ethoxylated alcohol is provided. The method comprises incorporating an ethoxylated alcohol and an antimicrobial agent into a polymer or a paper to impede virus spread. The method is particularly suitable for impeding enveloped virus spread.

In an embodiment of the invention, a method of using an ethoxylated alcohol is provided. The method comprises using an ethoxylated alcohol in combination with an antimicrobial agent to achieve an efficacy with less antimicrobial agent than is needed to achieve the efficacy with antimicrobial agent alone.

In an embodiment of the invention, a composition is provided having an antiviral effect. The composition comprises an ethoxylated alcohol and an antimicrobial agent.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

In accordance with the present invention, a method for impeding an enveloped viral spread is provided. The method comprises use of an ethoxylated alcohol, more preferably use of an ethoxylated alcohol in combination with an antimicrobial agent.

In an embodiment of the invention, the antimicrobial agent is selected from the group consisting of zinc pyrithione, quaternary ammonium silane, and a combination thereof.

In an embodiment of the invention, the antimicrobial agent is selected from the group consisting of a silver compound, a copper compound, a quaternary ammonium compound or a mixture of quaternary ammonium compounds, and a combination thereof.

In an embodiment of the invention, the antimicrobial agent is an organic acid.

Structurally, ethoxylated alcohols have a hydrophilic head group that is characterized by a repeating unit of an ethoxy component and a lipophilic tail group that is characterized by a linear carbon chain. The head group can be altered by altering the degree or moles of ethoxylation, from 1 to 16. The tail group typically has varying chain lengths from C4-C16.

In accordance with the method of the present invention, an ethoxylated alcohol(s) is combined with an antimicrobial agent to accentuate the activity of the antimicrobial agent against enveloped viruses by increasing the fluidity of the envelope layer. When the permeability of the envelope layer is altered, the penetrability and antiviral properties of the antimicrobial agent are believed to be amplified without a concurrent increase in antimicrobial concentration. The inclusion of the ethoxylated alcohol(s) allows a concomitant decrease in the amount of antimicrobial needed to achieve a similar benefit.

In the method of the present invention, the ethoxylated alcohol is used to accentuate the antiviral properties of an antimicrobial agent. This accentuation occurs across multiple classes of antimicrobial agents. Additionally, the carbon chain length and degree of ethoxylation may alter the observed accentuation benefit. Preferably, when the number of carbons is ≥9 carbons, the degree of ethoxylation is >5 moles of ethoxylation.

Additionally, the combination of the ethoxylated alcohol and the antimicrobial agent can be paired with other adjuvants depending on the end use scenario. For example, compatibilizers may be used to incorporate the ethoxylated alcohol into a polymer. Adjuvants for cleaning performance, streaking, shine, stability, and compatibility can be added for any of the below descriptions to allow for ease of use by the end consumer.

### Example 1. Multiple Chemistries with Ethoxylated Alcohols on Textiles

Two different antimicrobials were studied: zinc pyrithione and quaternary ammonium silane. Each chemistry was tested separately and in combination with the selected ethoxylated alcohol. The chemistries (with and without the ethoxylated alcohol) were pad-applied to a representative textile material and tested per ISO 18184 specification using an enveloped bacteriophage Phi6 (a much-studied surrogate of enveloped human viruses). A pass requirement in the ISO 18184 is a 2 log reduction (99% reduction). Table 1 shows that the antimicrobial agents have limited antiviral activity at the stated concentrations. However, addition of an ethoxylated alcohol increased the permeability of the envelope layer, thereby allowing access of the antimicrobial agent to the remainder of the virion. This accentuated the activity of the antimicrobial by increasing the log reduction from <1 log reduction to >3 log reduction when compared to the untreated controls. Thus, there was an unexpected and synergistic effect achieved with the combination of an ethoxylated alcohol and an antimicrobial agent. Results are shown in Table 1.

TABLE 1
The Antiviral Performance of Zinc Pyrithione When Applied
With or Without Ethoxylated Alcohol to Textiles

| Sample | | Viable | Log |
|---|---|---|---|
| # | Sample description | organisms | reduction |
| | Inoculum [Plate Count (Phi6 stock S | 2000000 | |
| | diluted in Butterfield's Buffer without | | |
| | additional soil) 2 hour contact time.] | | |
| 1 | Textile with 0.336% Zinc pyrithione | <20 | 4.8 |
| | and 0.5% Ethoxy alcohol, replicate 1 | | |
| 2 | Textile with 0.336% Zinc pyrithione | 500 | 3.4 |
| | and 0.5% Ethoxy alcohol, replicate 2 | | |
| 3 | Textile with 0.336% Zinc pyrithione | 900 | 3.2 |
| | and 0.5% Ethoxy alcohol, replicate 3 | | |
| 4 | Textile with 0.336% Zinc pyrithione, | 720000 | 0.3 |
| | replicate 1 | | |
| 5 | Textile with 0.336% Zinc pyrithione, | 130000 | 1.0 |
| | replicate 2 | | |
| 6 | Textile with 0.336% Zinc pyrithione, | 184000 | 0.9 |
| | replicate 3 | | |
| 7 | Textile control, replicate 1 | 1500000 | |
| 8 | Textile control, replicate 2 | 1340000 | |
| 9 | Textile control, replicate 3 | 1260000 | |
| | Mean of untreated control for | 1363082 | |
| | reduction calculation | | |

TABLE 2
The Antiviral Performance of Quaternary Ammonium Silane When
Applied With or Without Ethoxylated Alcohol to Textiles

| Sample | | Viable | Log |
|---|---|---|---|
| # | Sample description | organisms | reduction |
| | Inoculum [Plate Count (Phi6 stock S | 2560000 | |
| | diluted in Butterfield's Buffer without | | |
| | additional soil) 2 hour contact time.] | | |
| 1 | Textile with 0.972% Quaternary | 200 | 4.4 |
| | Ammonium Silane and 0.5% Ethoxy | | |
| | alcohol, replicate 1 | | |
| 2 | Textile with 0.972% Quaternary | <200 | 4.4 |
| | Ammonium Silane and 0.5% Ethoxy | | |
| | alcohol, replicate 2 | | |
| 3 | Textile with 0.972% Quaternary | <200 | 4.4 |
| | Ammonium Silane and 0.5% Ethoxy | | |
| | alcohol, replicate 3 | | |
| 4 | Textile with 0.972% Quaternary | 2020000 | 0.4 |
| | Ammonium Silane, replicate 1 | | |
| 5 | Textile with 0.972% Quaternary | 5840000 | −0.1 |
| | Ammonium Silane, replicate 2 | | |
| 6 | Textile with 0.972% Quaternary | 2560000 | 0.3 |
| | Ammonium Silane, replicate 3 | | |
| 7 | Textile control, replicate 1 | 6000000 | |
| 8 | Textile control, replicate 2 | 3820000 | |
| 9 | Textile control, replicate 3 | 4620000 | |
| | Mean of untreated control for | 4730992 | |
| | reduction calculation | | |

### Example 2. Different Carbon Chain Lengths and Degree of Ethoxylation (EO)

For use as a liquid, only one antimicrobial was selected for evaluation. The material was formulated into a spray product with quaternary silane as the base antimicrobial. Two different ethoxylated alcohols were utilized. One had a 9-carbon chain length with 5 EO and the other was a mixture of compounds with a range of carbon chain lengths from C12-C14 and 12 EO. These were tested per a modified EPA 01-1A where a “pass” criterion is set at a minimum of 99.9% reduction (3 log reduction). In summary, the antimicrobial formulation was applied to a glass substrate and allowed to dry. Once dry, the durability of the film was tested by exposing it to wet and dry abrasions (that simulate cleaning actions) with a Gardco wear tester. The film was then inoculated with a known concentration of enveloped virus (Phi6) and assessed for the surviving viral particles against the untreated controls to measure antiviral activity. Table 2 below shows that the short carbon chain ethoxylated alcohol (C9, 5EO) did not provide sufficient permeabilization of the envelope to allow quaternary silane to act upon the virion, resulting in a failing result (no efficacy). The combination of the quaternary silane with the longer carbon chain ethoxylated alcohol (C12-15, 12EO) provided passing results (≥99.9% reduction).

TABLE 3
The Effect of Carbon Chain Length and Degree of Ethoxylation
on Antiviral Efficacy of An Antimicrobial

| | Mean viable | % | |
|---|---|---|---|
| Sample description | organisms | Reduction | |
| Control | 37641 | | |
| Quaternary Ammonium Silane with | 3032 | 91.95 | Fail |
| C9, 5EO | | | |
| Control | 123623 | | |
| Quaternary Ammonium Silane with | <10 | 99.99 | Pass |
| C12-15, 12EO | | | |

The specific combination of the ethoxylated alcohol can be used to accentuate the antiviral efficacy of existing antimicrobials. The ethoxylated alcohol in combination with an antimicrobial can be utilized as a spray, concentrate, foam, fogging, wipe, or alternate format. The ethoxylated alcohol in combination with an antimicrobial can be applied to a textile via a spray, pad bath, exhaust bath, kiss roller, or embossing. The ethoxylated alcohol combination with an antimicrobial can be incorporated into paper via a masterbatch during milling or during finishing as described for the textile. The ethoxylated alcohol in combination with an antimicrobial can be incorporated into a polymer in a masterbatch or end use concentration.

The specific combination of the ethoxylated alcohol can be used to accentuate the antiviral efficacy of existing antimicrobials.

Present technologies only allow for immediate disinfection of the virus. Immediately following a touch, cough, sneeze, or settling of an aerosolization droplet the surface is re-contaminated. Viruses with high infectivity rates can survive on surfaces for days (Kramer et al, 2006). The combination and method of the present invention can provide continual antiviral protection on exposed surfaces in multiple formats. It can be incorporated into a solid surface, such as a textile or polymer, allowing surface protection. Additionally, it can be combined in a liquid based product for post-manufacture application.

Thus, in the present invention, ethoxylated alcohol is paired with an antimicrobial agent to enhance associated antiviral activity. Additionally, the antimicrobial and ethoxylated alcohol combination described herein shifts the parabolic distribution need of the degree of ethoxylation such as to 12 mol of ethoxylate.

### Example 3

A textile formulation was tested on polyester. The C12-15 and 12 mol ethoxylate was added ranging from 0.05 weight % to 0.5 weight % on weight of good. The material was pad-applied to the textile and then cured at 150° C. for 45 seconds. The material was tested for durability using 2 cycles of the AATCC 61(2A) protocol. As made, the material was able to reduce 99.9% (3 log reduction) of an enveloped bacteriophage (Phi6). Upon washing with 2 cycles of the 61(2A) protocol, the efficacy was still apparent but was reduced to 90% (1 log reduction) reduction of the Phi6 bacteriophage.

Additionally, a spray formula was tested for efficacy and durability against Phi6 (see example 2 above).

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A method of impeding virus spread, the method comprising:
using a combination of an ethoxylated alcohol and an antimicrobial agent to impede virus spread.

2. The method according to claim 1, wherein the virus is an enveloped virus.

3. The method according to claim 1, wherein the antimicrobial agent is selected from the group consisting of zinc pyrithione, quaternary ammonium silane, and a combination thereof.

4. The method according to claim 1, wherein the antimicrobial agent is selected from the group consisting of a silver compound, a copper compound, a quaternary ammonium compound or a mixture of quaternary ammonium compounds, and a combination thereof.

5. The method according to claim 1, wherein the antimicrobial agent is an organic acid.

6. The method according to claim 1, wherein the combination is applied to a substrate.

7. The method according to claim 6, wherein the substrate is a porous or non-porous surface.

8. The method according to claim 6, wherein the substrate is a textile.

9. The method according to claim 1, wherein the combination is incorporated into a polymer or a paper.

10. A method of using an ethoxylated alcohol, the method comprising:
applying an ethoxylated alcohol and an antimicrobial agent to a substrate to impede virus spread.

11. The method according to claim 10, wherein the antimicrobial agent is selected from the group consisting of zinc pyrithione, quaternary ammonium silane, and a combination thereof.

12. The method according to claim 10, wherein the antimicrobial agent is selected from the group consisting of a silver compound, a copper compound, a quaternary ammonium compound or a mixture of quaternary ammonium compounds, and a combination thereof.

13. The method according to claim 10, wherein the antimicrobial agent is an organic acid.

14. The method according to claim 10, wherein the substrate is a porous or non-porous surface.

15. The method according to claim 10, wherein the substrate is a textile.

16. A method of using an ethoxylated alcohol, the method comprising:
incorporating an ethoxylated alcohol and an antimicrobial agent into a polymer or a paper to impede virus spread.

17. The method according to claim 16, wherein the virus is an enveloped virus.

18. A method of using an ethoxylated alcohol, the method comprising:
using an ethoxylated alcohol in combination with an antimicrobial agent to achieve an efficacy with less antimicrobial agent than is needed to achieve the efficacy with antimicrobial agent alone.

19. A composition comprising:
an ethoxylated alcohol, and
an antimicrobial agent,
wherein the composition has an antiviral effect.

20. The composition according to claim 19, wherein the antimicrobial agent is selected from the group consisting of zinc pyrithione, quaternary ammonium silane, and a combination thereof.
